(19) United States
(12) Patent Application Publication
(10) Pub. No.: US 2009/0266567 A1
(43) Pub. Date: Oct. 29, 2009

(54) Fire suppression device

(76) Inventor: John E. Musser, JR., Tucson, AZ (US)

Correspondence Address: JOHN E. MUSSER, JR, 8362 S EGYPTIAN DR, TUCSON, AZ, 85747, US

(21) Appl. No.: 12/150,585

(22) Filed: Apr. 29, 2008

(51) Int. Cl. A62C 3/02

(52) U.S. Cl. 169/70

(57) ABSTRACT

The invention comprises a fire retarding device including a tarp or similar material impregnated with a fire retardant substance, cables, and a means for delivering the tarp to the site of a fire, such as one or more helicopters. The fire retarding device may include a flap of material for firefighters to use as a refuge and tie-downs to secure one or more portion of the tarp to a tree or other structure. The tarp may include pockets or pouches filled with ballast material to assist in the deployment of the tarp.

### BACKGROUND OF THE INVENTION

1. Field of the Invention

This invention is related in general to the field of fire suppression and fire protection and relates specifically to a device for retarding the spread of an existing fire. In particular, this invention includes a tarp impregnated with fire retardant substance, and said tarp may be dropped or dragged over an area that is on fire or is in danger of catching fire.

2. Description of the Prior Art

Current methods of fighting fires generally involve dousing a fire with water in order to cool it down or using a non-flammable chemical to smother the flames. Although such methods are often effective, they can also be inefficient because great quantities of water and/or fire suppression chemicals must typically be applied before a large fire can be brought under control. The weight and volume of water and fire suppression chemicals that must be used contribute to the expense of fighting a fire and also to the amount of work that must be performed. In addition, the use of large quantities of water can result in water damage to buildings and other items. Furthermore, the use of fire suppression chemicals in particular can have negative consequences for the environment. Accordingly, there is a need for a more efficient method of fire suppression that does not impact the environment through the introduction of large quantities of chemical substances or water.

In U.S. Pat. No. 6,474,420, Adiga discloses a method for controlling a fire using a metal screen with a catalytic coating. In the disclosed method, the indicated screen is lowered into a flame plume and transfers the heat release site from the flame to the screen, thus creating instability in the flame. The screen becomes the site of combustion and must, in turn, be put out itself. Accordingly, it is desirable to have a simpler device and method for fire suppression that works on the principle of smothering the fire rather than merely changing the nature of the combustion, thus eliminating the need for further steps and thereby making the process faster and more efficient. In addition, the cost of materials involved in coating a screen with catalyst may be avoided with a device that simply smothers a fire. Said smothering device would have the added advantage that it could generally be collected after use and used again, as necessary.

### SUMMARY OF THE INVENTION

The invention disclosed herein utilizes a fire suppression device comprising the use of one or more aircraft or airboats attached by cables to a large surface area pad of fabric or tarp material impregnated with a fire retardant substance, which may be dragged over a fire, or dropped on top of a fire or on a select area in danger of catching fire. The instant invention provides a means to smother a fire and to prevent the fire from encroaching upon a protected area or structure.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments, and particularly pointed out in the claims. However, such drawings and description disclose just a few of the various ways in which the invention may be practiced and are not limiting on the invention.

### BRIEF DESCRIPTION OF THE DRAWINGS

FIG. 1 is an illustration of a fire suppression system 100 including a fire suppression tarp 10, cables 14, and helicopters 200. The tarp is folded up and is carried by the helicopters to a forest fire site, illustrated by trees 60, smoke 50, and flames 55.

FIG. 2A is an illustration of the fire suppression system 100 including the body of the tarp 10 and cables 14.

FIG. 2B is an illustration of the fire suppression system 100 including the body of the tarp 10, cables 14, weighted portions 18, and tie straps 16.

FIG. 2C is an illustration of the fire suppression system 100 including the body of the tarp 10, cables 14, and a rolled up section or flap 20.

FIG. 3 is an illustration of the fire suppression system 100 including tie straps 16 tied to tree trunks 60, deployed at a forest fire.

FIG. 4 is an illustration of the fire suppression system 100 including tie straps 16 tied to tree trunks 60, deployed and released on a forest fire such that flames (not shown) have been extinguished.

FIG. 5 is an illustration of the fire suppression system 100 deployed and released on a house (not shown).

FIG. 6 is a cut-away illustration of the fire suppression system 100 deployed and released on a house 70.

### DESCRIPTION OF THE INVENTION

This invention relates to a fire suppression device for smothering flames or preventing flames from reaching an area. In particular, this invention comprises a tarp made of heavy fabric or a similar type of material, which has been treated so as to be fire resistant. Furthermore, this invention includes novel features comprising the use of helicopters and cables to transport the invention to the site of a fire.

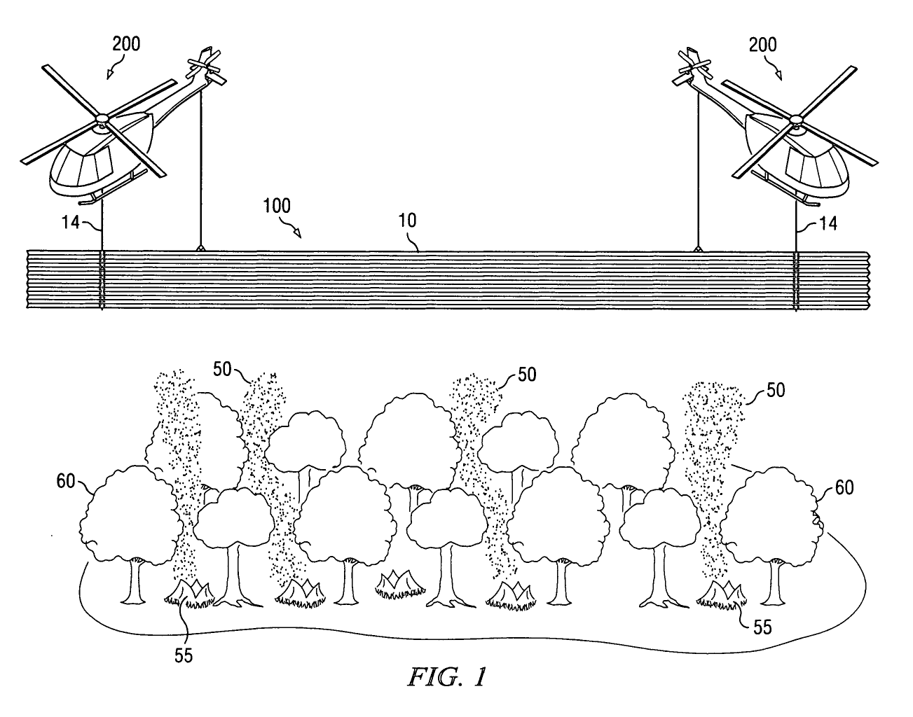

Referring to figures, wherein like parts are designated with like reference numerals and symbols, FIG. 1 is an illustration of a fire suppression device 100 including a fire suppression tarp 10, cables 14 and helicopters 200. The body of the tarp 10 is folded up and is carried by the helicopters to a forest fire site, illustrated by trees 60, smoke 50, and flames 55.

Aircraft are frequently utilized for combating large fires such as forest fires. The instant invention employs one or two helicopters to carry the fire suppression tarp to the site of a fire where it may then be deployed by releasing the tarp from a folded up position to an open one.

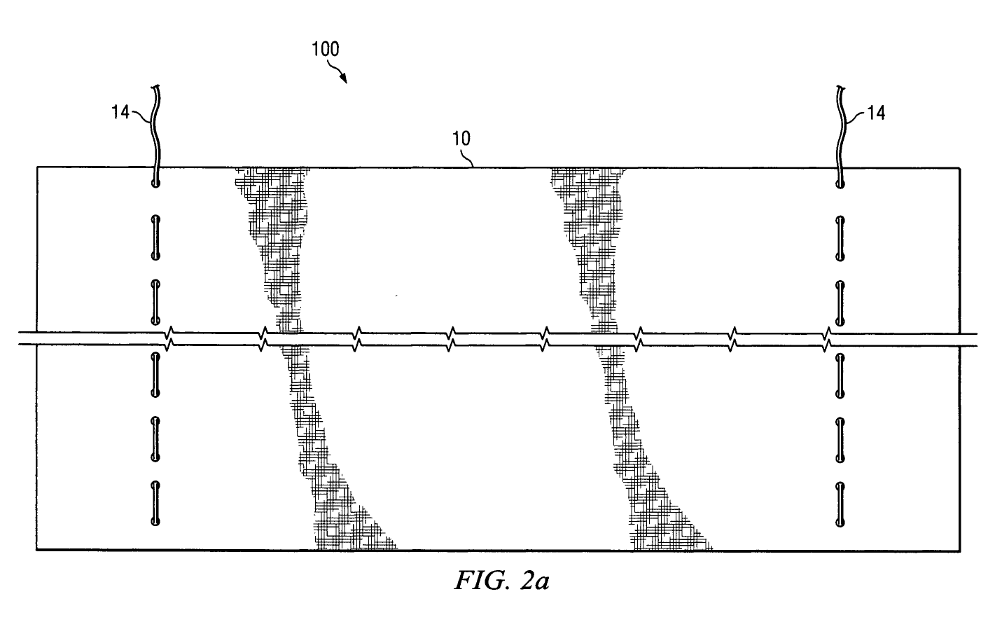

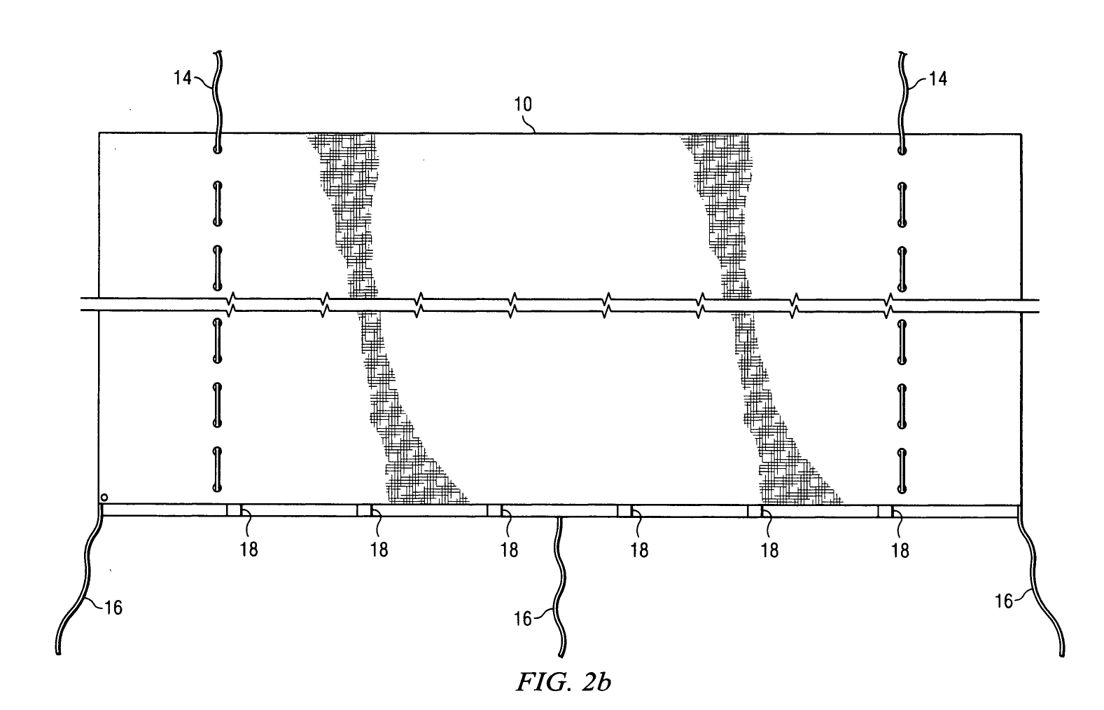

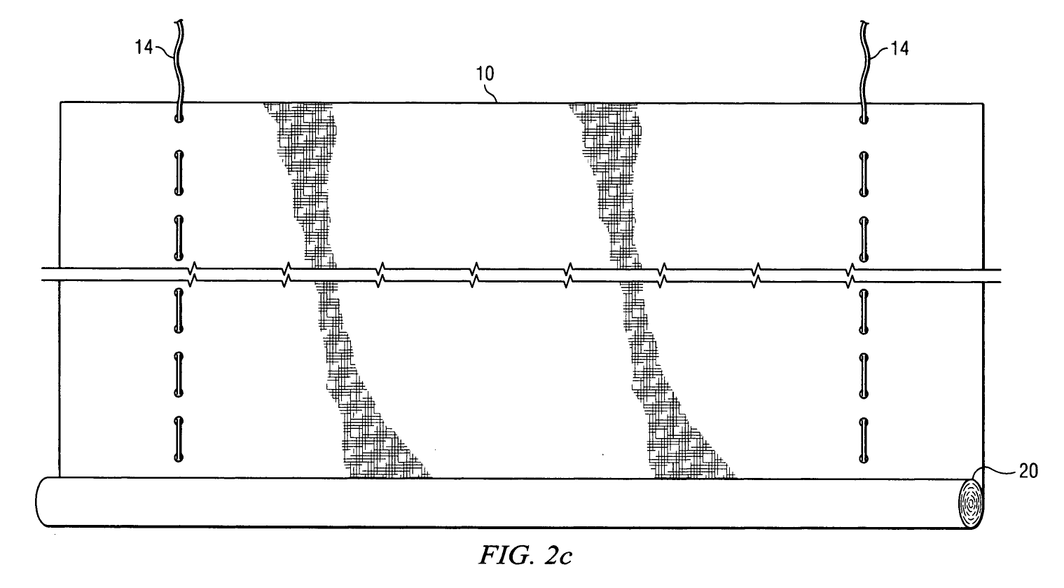

FIG. 2A is an illustration of the fire suppression device 100 including the body of the tarp 10 and cables 14. In the illustrated embodiment of the invention, cables 14 run down each side of the tarp by an attachment means, for example, eyelets. The body of the tarp 10 is comprised of heavy, durable fabric, or similar material, such that it can be folded and also draped over features such as trees, vegetation, or structures. Furthermore, the material of the body of the tarp 10 is treated with a fire retardant substance in order to render the tarp non-combustible. The weight of the material of the body of the tarp 10 combined with its non-combustible nature allow the tarp 100 to effective smother any fire on which it is dropped and, additionally, to prevent the spread of fire onto an unburned area on which the tarp is placed.

FIG. 2B is an illustration of an embodiment of the invention 100 including the body of the tarp 10, cables 14, weighted portions 18, and tie straps 16. In this embodiment, weighting material, for example sand, is incorporated in sections attached or sewn into the bottom area of the tarp 10. The weighted portions 18 allow the tarp to fully deploy and be guided toward the target area in the correct orientation. In addition, the weighted portions 18 may prevent the tarp from being blown back by updrafts that are caused by a fire.

Another element present in the embodiment of the invention illustrated in FIG. 2B is a system of tie straps 16. The tie straps 16 can be used by ground personnel to secure the leading edge of the tarp to tree trunks or other anchoring objects as the tarp is lowered. This is useful because this allows the tarp 100 to be secured over an area and also allows maximum use of the area of the tarp 100, which may be more easily stretched out fully if at least one end of the tarp 100 is secured. The use of tie straps 16 in this manner is expected to be most effective when the tarp 100 is used in advance of an approaching fire to protect unburned areas from catching fire.

FIG. 2C is an illustration of another embodiment of the invention 100 including the body of the tarp 10, cables 14, and a rolled up section or flap 20. The flap 20 in this embodiment of the invention 100 may be used as a safety feature. For example, if ground personnel are trapped as a fire approaches; the indicated personnel may lift the flap 20 portion of the tarp 100 and take shelter beneath it. Thus, even in a situation where tie straps (16, illustrated in FIG. 2B) are used to secure the leading edge of the tarp 100, endangered personnel may still unroll the flap 20, which is unrestrained.

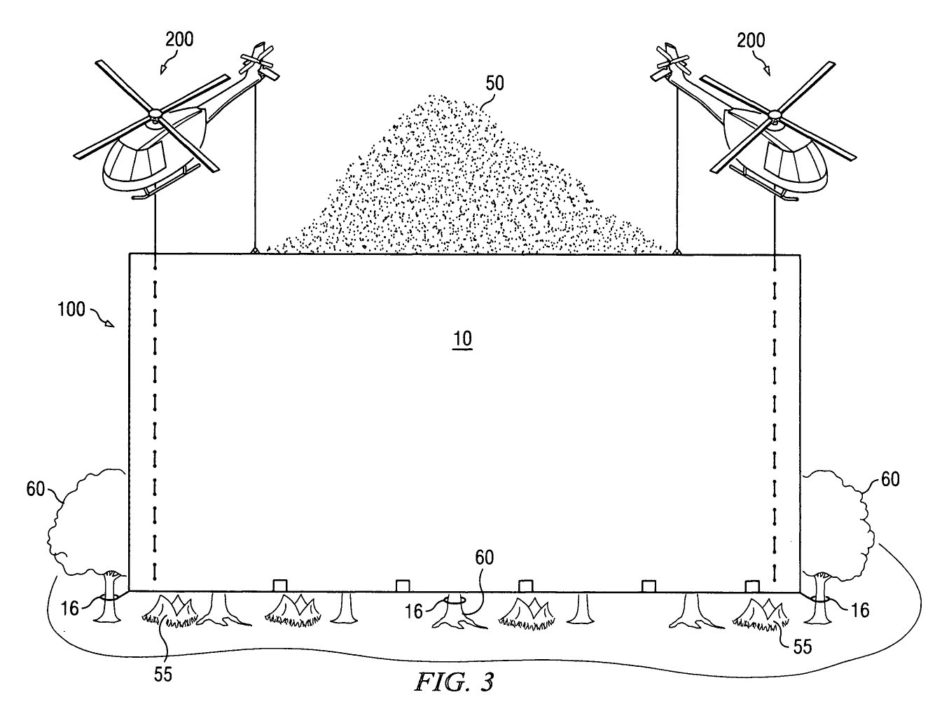

FIG. 3 is an illustration of an embodiment of the invention 100 including weighted portions 18 and tie straps 16 tied to tree trunks 60, deployed at a forest fire by helicopters 200. In this illustration, the tarp 100 is being deployed over a burning area in order to smother existing flames 55.

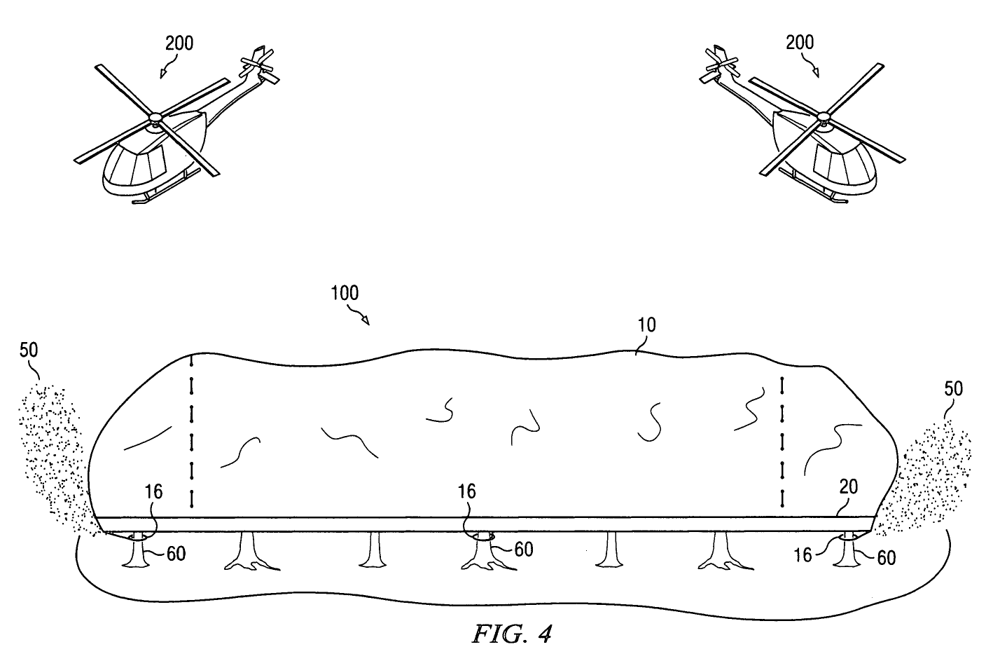

FIG. 4 is an illustration of an embodiment of the invention 100 including tie straps 16 tied to tree trunks 60, deployed and released by helicopters 200 onto a forest fire such that flames (not shown) have been extinguished.

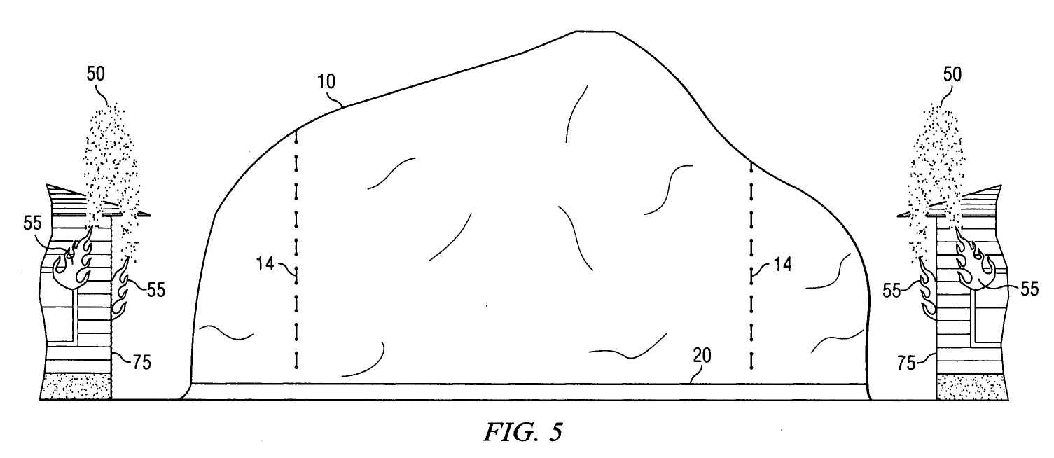

FIG. 5 is an illustration of an embodiment of the invention 100 deployed and released by helicopters 200 on a house (not shown). In the embodiment of the invention 100 illustrated in FIG. 5, the flexibility of the body of the tarp 10 allows it to drape over a house. Because the tarp is non-combustible, its use in this manner will prevent the spread of flames 55 from other burning houses 75.

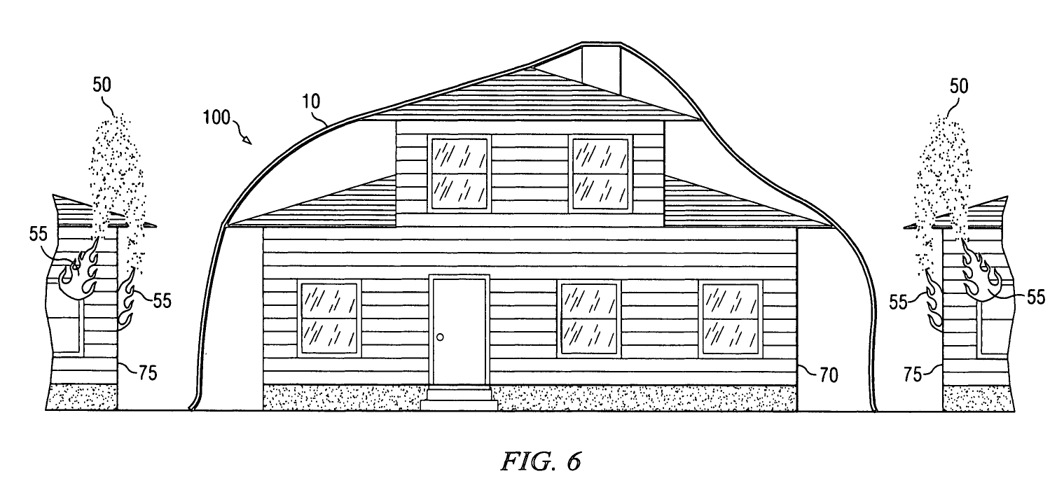

FIG. 6 is a cut-away illustration of the embodiment of the invention 100 illustrated in FIG. 5 deployed and released on a house 70. The house 70 is unaffected by the fire, which, in this illustration, is burning neighboring houses 75.

The use of the invention 100 to protect a house 70 from approaching fire is a novel means for fire prevention and fire fighting. It is anticipated that the tarp 10 may be used both to protect unburned structures and to quickly smother the flames on a burning structure. Several tarps may be used simultaneously to fully extinguish a fire over several houses or an even larger area.

The present invention may be embodied in other specific forms without departing from its spirit or essential characteristics. The described embodiments are to be considered in all respects only as illustrative and not restrictive. All changes which come within the meaning and range of equivalency of the claims are to be embraced within their scope.

I claim:

1. A Fire Suppression Device comprising:
a tarp impregnated with a fire retardant substance having a first end and a second end;
a first cable attached to a first end of the tarp; and
a first means for transporting the tarp attached to the first cable.

2. The fire suppression device of claim 1, wherein the tarp includes a tie strap attached to the first end and adapted to secure the tarp.

3. The fire suppression device of claim 1, wherein the tarp includes a weighted portion adapted to facilitate the deployment of the tarp.

4. The fire suppression device of claim 1, wherein the tarp includes a flap adapted to protect a person.

5. The fire suppression device of claim 1, wherein the means for transporting the tarp includes a first helicopter.

6. The fire suppression device of claim 1, wherein the tarp is comprised of a flexible material.

7. The fire suppression device of claim 6, wherein the flexible material is fabric.

8. The fire suppression device of claim 5, further comprising a second cable attached to the second end of the tarp and a second means for transporting the tarp.

9. The fire suppression device of claim 8, wherein the second means for transporting the tarp includes a second helicopter.
